(19) United States
(12) Patent Application Publication
(10) Pub. No.: US 2014/0138236 A1
(43) Pub. Date: May 22, 2014

(54) ATMOSPHERIC WATER GENERATOR SYSTEM

(71) Applicant: Keith White, Mission (CA)

(72) Inventor: Keith White, Mission (CA)

(73) Assignee: AWG INTERNATIONAL, INC., Bothell, WA (US)

(21) Appl. No.: 14/234,614

(22) PCT Filed: May 24, 2012
(86) PCT No.: PCT/US2012/039436

§ 371 Date: Jan. 23, 2014

Related U.S. Application Data
(60) Provisional application No. 61/489,588, filed on May 24, 2011.

(51) Int. Cl. C02F 1/04

(52) U.S. Cl. CPC C02F 1/04
USPC 202/185.3; 202/185.1

(57) ABSTRACT

An atmospheric water generator and system for condensing and collecting moisture contained in the air serves to cool and dehumidify the air. One aspect of the design includes generation of electricity via a turbine configured to be actuated by an increase in gas pressure from heat transfer fluid in a continuous heat transfer fluid system as it exits the evaporator. In alternative embodiments, the system can be used in a multi-zone application or to provide cooled air and water to a building. An embodiment primarily for use as an air conditioning unit is also described. Alternatively, fly-back technology is used to configure solar or wind powered DC current for use by a water generation system. In certain environments oil free compressors are employed in the water generation unit.

### BACKGROUND

1. Technical Field

The present disclosure relates to systems for producing potable water from air. More particularly this disclosure relates to atmospheric water generators that collect, sterilize, store, and dispense water extracted from the atmosphere.

2. Description of the Related Art

Atmospheric water generators are used to provide water to areas that do not otherwise have sufficient natural water resources to provide for the needs of human residents, animals and plants.

In a series of applications (U.S. Pat. No. 7,272,947, U.S. Pub. Nos. 2008/0022694 and 2009/0077992, each of which is hereby incorporated by reference), Anderson and White describe a water producing system adapted to condense water from the air and collect it in a storage tank. Condensed water drips down into a collection tray, and then passes through a conduit into a main storage tank. Ozone gas is bubbled or injected the main tank to kill any bacteria. The main drawbacks to this system are the need to remove the ozone from the water in order to render it potable and the need to use ozone-resistant materials for the tank and associated fittings, which can increase the cost of the system. Further, excess ozone must be vented in order to avoid an increased pressure within the main tank. However, as airborne ozone is an irritant, inhalation of which can worsen asthma and cause coughing, wheezing, throat irritation and chest pains, there is a need for an additional filtering system to convert the ozone gas into oxygen gas before it can be vented into the atmosphere. In addition, the system shown does not explicitly deal with the need to filter organic matter, from which endotoxins can form within the tank. Finally, the carbon filters in the system can be very difficult to maintain, as the filtering process can lead to coalescence of the carbon filtration material, blocking the filter.

### BRIEF SUMMARY

The present disclosure is directed to an atmospheric water generation system that draws moisture-laden air into an enclosed area, cools it to condense out the moisture that is collected in a tank, and then vents the dry air back into the atmosphere. The condensed water is collected in a lower portion of the tank, then is pumped out of the tank and purified before being returned to the tank, thereby keeping the collected water from becoming stagnant.

In accordance with another aspect of the present disclosure, an atmospheric water generator is provided that is self-sustaining in that it provides for electrical power generation while extracting water from the atmosphere. The generator includes a continuous flow of heat transfer fluid through an evaporator and a condenser unit in which a turbine is coupled between the output of the evaporator and an input of the condenser. The turbine turns a shaft coupled to an electric generator, and the turbine is actuated by an increase in gas pressure from the heat transfer fluid as it exits the evaporator. A pump is coupled to an input of the evaporator and draws the heat transfer fluid from an output of the condenser.

In accordance with a further aspect of the present disclosure, the foregoing system can be used on an industrial scale to provide heating, dehumidification, air conditioning and clean water to an area, such as a house, with multiple zones, or on a larger scale, such as in an apartment building with several units.

In accordance with still yet another aspect of the present disclosure, a noise reduction system is incorporated into an atmospheric water generation system. Ideally an active noise reduction system is used in areas where noise is typically generated, including motor enclosures and ducting.

In accordance with a further aspect of the present disclosure, a UV purification system is incorporated into the atmospheric water generation system. In one embodiment, a junction box comprised of a stainless steel, watertight housing is provided with highly polished internal surfaces for light reflection such as from reflectors, deflectors or diffuser or a combination thereof within the housing to scatter light. The housing can include internal walls or baffles to create flow channels that provide for additional exposure to light. For example, multiple lasers can be used inside each chamber formed by the walls, and each laser can have a unique wavelength to cover a wide range of wavelengths. Preferably the treatment occurs as close to the point of use as possible.

The foregoing was intended as a broad summary only and of only some of the aspects of the disclosure. Other aspects of the disclosure will be more fully appreciated by reference to the detailed description of the preferred embodiment. Moreover, despite this disclosure, the actual disclosure, inventive apparatus, methods, concepts and inventive ideas for which this patent is sought are ultimately defined only by the formal claims of this application, not by the details of the summary or of the preferred embodiment.

### BRIEF DESCRIPTION OF THE SEVERAL VIEWS OF THE DRAWING(S)

The foregoing and other features and advantages of the present disclosure will be more readily appreciated as the same become better understood from the following detailed description when taken in conjunction with the accompanying drawings, where:

FIG. 1 is a schematic of an atmospheric water generator according to one embodiment of the disclosure;

FIG. 2 is a schematic of an atmospheric water generator according to another embodiment of the disclosure;

FIGS. 3A and 3B are schematics of atmospheric water generators according to further aspects of the present disclosure;

FIG. 4 is a schematic of an atmospheric water generation, heating, dehumidification and air conditioning system according to an embodiment of the disclosure;

FIG. 5 is a schematic of a multi-room atmospheric water generation, heating, dehumidification and air conditioning system according to an embodiment of the disclosure;

FIG. 6 is a schematic of an air conditioning system using an atmospheric water generator according to an embodiment of the disclosure;

FIG. 7 illustrates an atmospheric water generation system formed in accordance with another aspect of the present disclosure to include electric power generation;

FIG. 8 is an isometric illustration of a self-contained water generation, treatment, and dispensing system formed in accordance with the present disclosure;

FIG. 9 is a diagram of air and water product flow in a recirculating system using a desiccant wheel;

FIG. 10 is a diagram of an alternative configuration of a water generation, treatment, and dispensing system using the desiccant wheel;

FIG. 11 is a diagram of the system of FIG. 10 showing alternative compressor locations in the system;

FIG. 12 is a diagram illustrating system configurations with alternative power sources for residential, governmental, and commercial structures;

FIG. 13 is a diagram illustrating a system configuration for recirculation of water in greenhouses; and

FIGS. 14 and 15 are illustrations of another embodiment of a water generation system formed in accordance with the present disclosure;

FIG. 16 is a schematic of the water generation system of FIGS. 14-15; and

FIGS. 17-20 are isometric, top, front, and side views, respectively of another water generation system design formed in accordance with the present disclosure.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures or components or both associated with projection systems, including but not limited to power supplies, controllers, and related software have not been shown or described in order to avoid unnecessarily obscuring descriptions of the embodiments.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

In the embodiments described herein, like elements are depicted with identical reference numbers.

Heat pump/refrigeration cycles are well understood in thermodynamic disciplines and generally include a condenser, an expander, an evaporator, a compressor and a refrigerant fluid. Some basic background information on the heat pump cycle is provided herein. The condenser and expanders are generally heat exchangers in some form which comprise elongated tubes structure in a manner to maximize the exposed surface area. The heat pump forms a close-loop circuit where the refrigerant fluid constantly heats up and cools down at various portions within the elongated tubes. As the refrigerant fluid exits a compressor, the pressure of the compressing fluid is increased substantially pursuant to the natural gas law of PV=nRT, resulting in a temperature increase in the fluid. The compressor is in communication with the condenser and the exiting hot refrigerant fluid, which is warmer than the ambient conditions, will cool down and condense to a liquid within the close looped system. Therefore, the refrigerant, which is now under high pressure and in liquid form within the condenser, passes to an expander, which is in fluid form and interposed between the evaporator and the condenser tubing or coils.

The expander in general is an orifice type restrictor that maintains a pressure drop from the upstream side (near the condenser) to the downstream side (near the evaporator). The expander allows for a higher pressure within the condenser and when the refrigerant passes there through, the expansion of the refrigerant provides for immediate cooling which lowers the temperature of the evaporator. Therefore, the cool refrigerant, which is at a temperature below ambient conditions, draws heat from adjacent ambient air. Because the refrigerant has expanded to lower pressure, pursuant to the natural gas law of PV=nRT (or one of the equivalent natural gas equations) the temperature drops commensurately with the drop of the pressure to balance this equation. The drop in temperature is conducted through the outer surface of the evaporator coil and this heat gradient with the ambient temperature draws heat thereto. Depending upon the location within the close-loop stream in the evaporator, the refrigerant having a rather low boiling point will evaporate therein drawing heat from the ambient conditions. Thereafter, the gaseous refrigerant passes to the compressor where it is re-compressed and the closed looped circuit continues.

What follows next is a description of one embodiment of a device and system to extract, purify and deliver water. It should be noted that described throughout there are various combinations for executing various functions of the water producing device. For example, there is a plurality of ways of cooling the water condensate member or coils. Further, various methods of purifying the water are described, many of which can be used in conjunction with the various methods of condensing and obtaining the water. Therefore, it should be appreciated that various combinations of elements can be combined for a wide variety of embodiments which are greater than the number of figures disclosed herein. Further, various optional components such as hot and cold water tanks can be incorporated.

Generally an atmospheric water generator and system for condensing and collecting moisture contained in the air is provided that serves to cool and dehumidify the air. One aspect of the design includes generation of electricity via a turbine configured to be actuated by an increase in gas pressure from heat transfer fluid in a continuous heat transfer fluid system as it exits an evaporator in the system. In alternative embodiments, the system can be used in a multi-zone application or to provide cooled air and water to a building. An embodiment primarily for use as an air conditioning unit is also described. Fly-back technology is used to configure solar or wind powered DC current for use by a water generation system. In certain environments oil free compressors are employed in the water generation unit. Deep coil technology is implemented for more efficient generation of water.

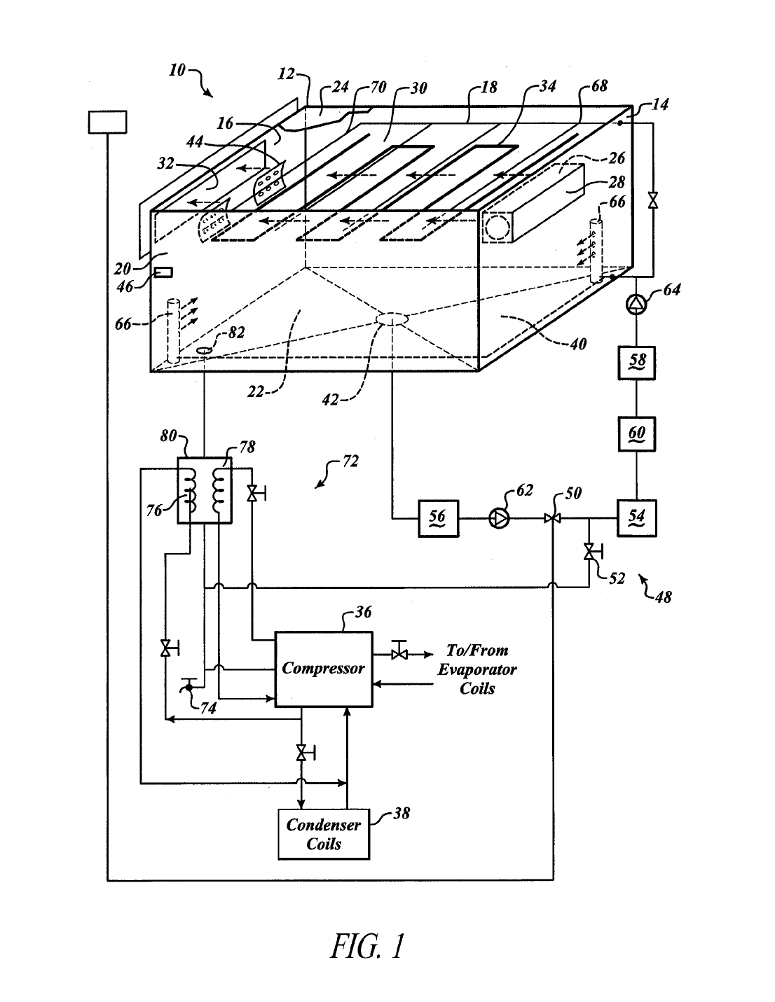

FIG. 1 shows a first embodiment of an atmospheric water generator 10 according to the disclosure. The generator 10 includes a tank 12 having a front wall 14, back wall 16, first and second side walls 18, 20, a bottom wall 22, and a top wall 24 (shown in partial cutaway for purposes of illustration). A fan 26, preferably positioned in an interior of the tank 12 and ducted to minimize noise and act as a muffler system as well as maintains a positive pressure in the tank, pulls air (shown with dashed arrows) through an inlet 28 from the surrounding area, such as a room, into a water condensation portion 30 of the generator tank 12, and the air then exits the tank 12 through an outlet opening 32. The fan 26 may also serve as a primary air filter. The air passes across one or more water condensing members or evaporator coils 34, which are preferably evaporation coils coated with titanium oxide, or stainless steel, or any other appropriate material, which should be of a food grade coating or a coating that would not allow the leaching of aluminum into the water and fit for potable applications. Moisture in the air condenses on the evaporator coils 34, from where it then drips down onto the bottom wall or condenser receiving tray 22 and accumulates in the tank 12.

The evaporator coils 34 are in fluid communication with a compressor 36 that is also in fluid communication with condensing coils 38. The compressor 36 compresses a refrigerant fluid through the condensing coils 38 to condense the operating refrigerant fluid/gas, which generates heat. The air around the condensing coils 38 is cooled via conventional means. The fluid passes from the condensing coils 38 to the water condensing coils 34 where the water condenses on the outer surface.

In the present design, the evaporator or water condenser coils 34 are ideally covered with a food grade coating. This may include, without limitation, stainless steel or titanium oxide, for example, and other commercially available coatings that can be applied by spraying, dipping, and other known methods. Ideally, the coating provides for corrosion resistance without inhibiting the condensation of water for potable applications, e.g., meets U.S. Department of Agriculture requirements for contact surfaces.

The water condensing members or coils 34 may be finned, to provide more surface area with which to condense water from the air. The cooled air, which has been divested of much of its moisture, is then vented out of the generator tank 12 back into the atmosphere through a suitable outlet 32 while the collected water moves into the collection portion 40 of the generator tank 12. Ideally the bottom wall (condenser receiving tray) 22 is structured to direct the water to a central collection point 42 that is the lowest point in the tank 12.

The water condensing members or coils 34 are cooled with any suitable refrigerant moved through by the compressor 36, which is preferably a variable speed compressor, but which may be any suitable compressor, such as a rotary or reciprocating compressor. The refrigerant passes through the condenser coils 36 to remove heat before returning to the compressor. If it is preferable not to vent cooled air, one or more condensing coils 38, which form part of the heat pump cycle including the water condensing members or evaporator coils 34 and the compressor 36, may be placed near the outlet of the generator tank, in order to heat the air as it is vented back into the room.

The water condensing portion 30 of the system may further comprise a diverter 44, consisting of one or more perforated sheets of suitable material, such as plastic or stainless steel plates. The diverter 44 is located across the condensing member from the fan and adjacent the exit opening 32 and it serves to divert a portion of the air back into the system for another pass across the evaporator coils, thereby increasing the efficiency of the water condensation system. The perforated sheets may be of any suitable shape, such as flat or curved, and orientation, such as perpendicular or angled relative to the airflow direction, to divert a suitable proportion of the air brought in by the fan back across the condensing member.

A sensor 46 may be placed in the generator tank to indicate when the collected water level is becoming too high.

From the collection portion 42 of the generator tank 12, the condensed water moves through a purification system 48. In the embodiment shown in FIG. 1, the purification system 48 is an external circuit, in which ozone may be injected into the water via an ozone injector 50, killing any bacteria and other impurities in the water as it passes the injection area. The ozone may then immediately be purged from the purification circuit 48. A valve 52 is gravity fed from the heating-cooling unit 80 to form a circulation loop from the tank 80 back into the purification circuit 48. If the spigot 74 was not in use for an extended period, there would be no water flow in the dispensing loop and it would in effect become a dead leg and could grow bacteria. It should also be noted that 52 can connect either upstream of 50 or downstream as shown in FIG. 1. The water continues through a purification chamber 54, where it may be further treated by any suitable means, such as an ion exchange, LED, titanium oxide, ultraviolet or carbon filter, or any combination of the foregoing. The external application of the ozone gas, combined with the relatively immediate removal of the injected ozone, minimizes the portion of the generator system that must be composed of ozone-resistant material, as well as requiring low amounts of ozone and preventing any large pressure buildup in the system. In the alternative, the ozone injection portion of the purification system may be omitted, and the water can simply be purified in the purification chamber, by any suitable means, such as ion exchange, LED, titanium oxide, ultraviolet or carbon filtration or any combination of the foregoing. The purification system can include an optional pre-filter 56 positioned upstream from the ozone injector 50, as well as hot and cold dispensers 58, 60. A conventional pump 62 draws the water into the purification system 48 and an optional second pump 64 can be used to push the water back into the tank through at least one stand pipe 66, and preferably two stand pipes 66 located in opposing corners of the tank 12 that direct the water to flow in the tank 12, ideally in a circular fashion, such as clockwise or counterclockwise. The movement of the water prevents stagnation and the build-up of impurities as well as scrubs surfaces on the interior of the tank that are in contact with the water, such as the bottom wall 22, and portions of the front wall 14, rear wall 16, and side walls 18 and 20. Ideally, the stand pipes 66 are jetted or contain nozzles to provide more force and directional movement of the filtered water as it exits the stand pipe 66.

The purified water can be dispensed through a dispensing portion 72 of the system as required through a spigot 74, while any excess water may return to the lower portion of the generator tank 12. The pressure and direction of the purified water return is such as to cause the water to move about the inner perimeter of the generator tank, such as the jetted pipes 66 described above, which scrubs down the sides of the tank, preventing buildup of organic or other undesirable matter, particularly at or near the waterline. The pipes 66 need not be jetted and can merely be openings in the pipes 66 directionally oriented to provide the desired direction of water movement in the tank 12.

Another optional feature is the coil clean system 68 that conducts water through pipes 70 located over the evaporator coils 34 controlled by a suitable valve and manual or automatic control system to dispense water on to the coils 34 to clean the coils 34, as well as aid in cooling the coils 34 as well as acting to defrost the coils 34 in the event of ice build up on the coils 34. At least a portion of the purified water is thus diverted to periodically flow over and rinse the evaporator coils 34 and diverter 44, thereby minimizing any dirt or scale buildup in the upper portion of the generator tank.

The dispensing portion 72 of the system may include means by which the water temperature can be adjusted as required by the user. For example, a heating coil 76, which may be electric or which may be heated by hot gas from the compressor 36 or by any other suitable method, may heat the water as it passes through the dispensing portion of the generator system. In the alternative, any similar rapid, preferably direct-contact, heating method may also be used. In addition, or in the alternative, if hot water is not required for a specific application, a cooling coil 78, which again may be electric, or which may be cooled by the compressor or by any other suitable cooling method, may cool the water as it passes through the dispensing portion of the generator system. One or both coils 76, 78 can be housed in a heating-cooling unit 80 in fluid communication with a dispensing outlet 82 in the bottom wall 22 of the tank 12.

Ideally, the heating coil 76 is electric, about 500 Watts, and provides fast heat with no more than a 4 to 5 second delay. Similarly, the cooling coil 78 may be electric or be coupled to the evaporator coil for maximum of 3-second delay in chilling the water.

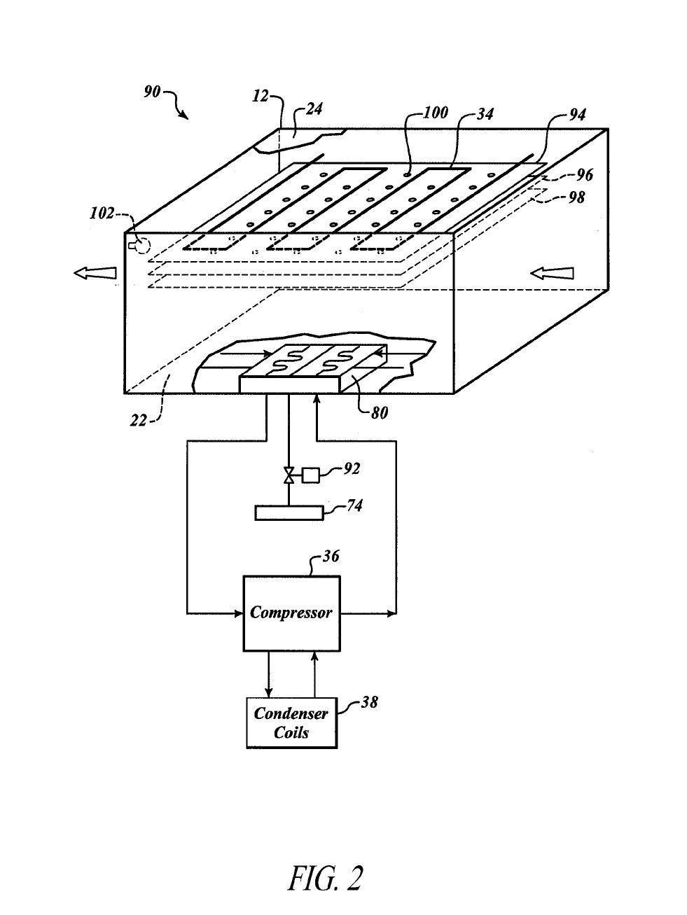

In alternate embodiments, the water generation system 90 shown in FIG. 2 has the heating-cooling unit 80 moved to the interior of the tank 12, such as on the interior side of the bottom wall 22. Water is dispensed to the spigot 74 through a solenoid valve 92. In addition, a purification mechanism or mechanisms formed of one or more titanium oxide plates 94, 96, 98, are positioned under the evaporator coils 34 to collect the water that falls from the coils 34. In this way, an ozone-free water generation system is provided. In one embodiment, the top plate 94 is coated with titanium oxide food grade coating and includes holes or openings 100 to allow water to flow there through. The intermediate plate 96 can be a sediment filter while the bottom filter 98 can be a carbon filter element. An optional pump can be used in the tank 12 to circulate water. Other parts of the system, such as the evaporation portion, are similar to those shown in FIG. 1. This embodiment eliminates all use of ozone.

As in the embodiment shown in FIG. 2, all or part of the dispensing portion 72 of the system 90 can be located within a generator tank housing that includes the tank 12. Heating and/or cooling coils as discussed above may be located within a chamber 80 within the tank 12, and the collected water passes through the chamber 80 to be heated or cooled before being dispensed. An optional light 102, such as an LED, is provided for purification as desired.

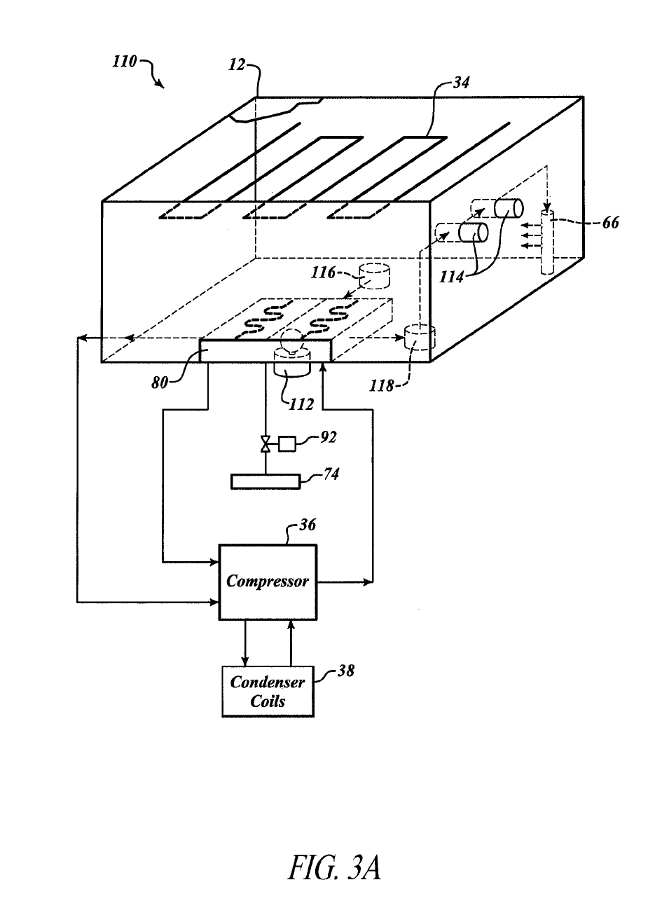

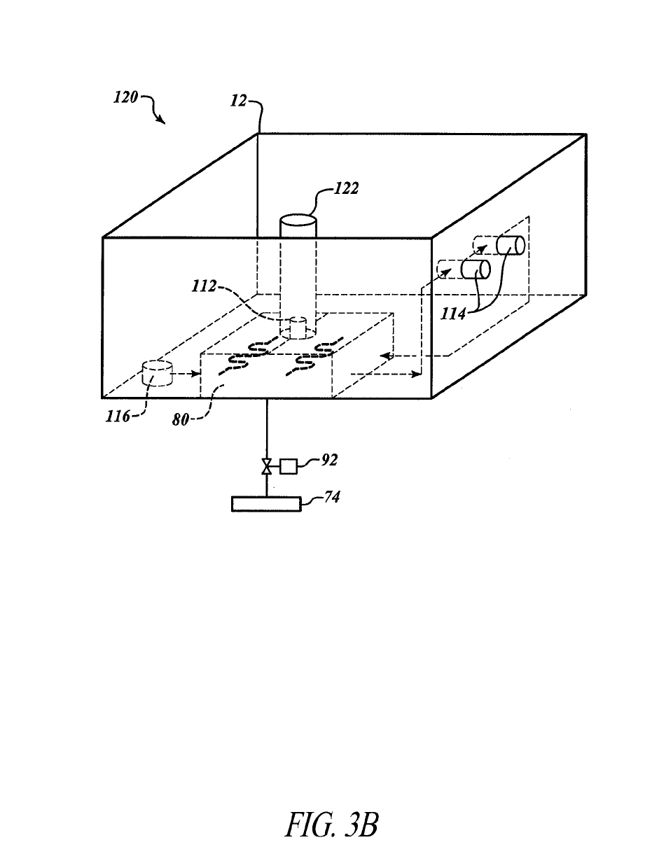

In the embodiment shown in FIG. 3A, the purification system 110 is ozone free and can take the form of one or more LEDs 112 placed outside the tank 12 to treat water as it passes through the heating-cooling unit 80, which have the benefit of longevity without producing heat inside the tank 12, as cool water is preferable in order to minimize bacteria propagation. The LEDs 112 preferably have a wavelength of up to approximately 365 nm in order to effectively kill any bacteria in the water. In one aspect, the wavelength of the LED is in the range up to 365 nm and ideally from 265 nm through 285 nm, and more preferably at 280 nm. The generator tank 12 may also be provided with one or more external filters 114 that can be periodically changed by the user. One filter may be a sediment filter and the other a carbon filter, with the output from the last filter going to the stand pipe 66. Other parts of the system 110, such as the evaporation portion with evaporator coils 34, are similar to that shown in FIG. 1, while the dispensing portion of the system can be internal, as shown in FIG. 2, or may be external, as shown in FIG. 1. In the internal version shown in FIG. 3A, two pumps 116, 118 are used to push and pull water through the unit 80, respectively. The pumps 116, 118 may be coupled to the LED 112 to control operation, e.g., the external LED 112 is energized when the pumps 116, 118 are energized.

FIG. 3B show a system 120 similar to the system 110 of FIG. 3A, except here the LED lamp 112 is positioned inside the tank 12 above the heating-cooling unit 80 and inside a clear tube 122. More particularly the tube 122 is solid and serves only to house the LED lamp 112, which has its beam directed to shine inside the heating-cooling unit 80 where water is pumped through by the pump 116 at a prescribed flow rate to control the bacteria. Filters 114 are mounted in the front wall of the tank 12 so as to be replaceable from the exterior of the tank 12. A single pump 116 is used to move the water in the tank 112 to prevent stagnation and scrub surfaces in the tank 112 that are in contact with the water. In this version the tank can be of a portable size. For example, it can be 10 inches high, 20 inches deep, and 20 inches wide and hold about 5 gallons of water. It includes the evaporator coils and other elements described above necessary to produce the water. The heating-cooling unit 80 is ideally structure to hold about 8 ounces to 16 ounces of water.

An additional improvement provided by the present disclosure is the combination of UV laser light with the water generation systems disclosed herein, either alone or in combination with the LED version described above, to purify the water. According to the CDC, during the past 2 decades, Cryptosporidium and Giardia have become recognized as two of the most prevalent causes of waterborne disease (drinking and recreational) in humans in the United States. These microorganisms are found in every region of the Country and throughout the world. UV laser light systems have been found to be very effective in eliminating and reducing the risk of these pathogens surviving purification treatment.

Ideally, the UV laser treatment takes place as close to the point of dispensing as possible. The UV laser provides increased UV exposure via focal irradiation of pathogens in a smaller process stream. More microorganisms are reduced or eliminated and greater uniformity in effectiveness is achieved. As water passes through the treatment area, microorganisms contained in the fluid are subjected to light reactive at a predetermined wavelength. When photons of UV laser light energy are absorbed by the microorganism DNA, the base-pair hydrogen bond is ruptured, causing disruption in the DNA chain. When the cell undergoes mitosis (cell division) with the DNA chain disrupted, the DNA is unable to replicate and it thereby renders the microorganism harmless. Viruses also contain nucleic acid and are neutralized in a similar manner. Ideally, the UV laser light should have a wavelength in the range from 110 nm to and including 280 nm and energy per photon in the range of 4.43 eV to and including 12.4 eV.

Because UV laser light treatment is readily commercially available, it will not be described in detail herein.

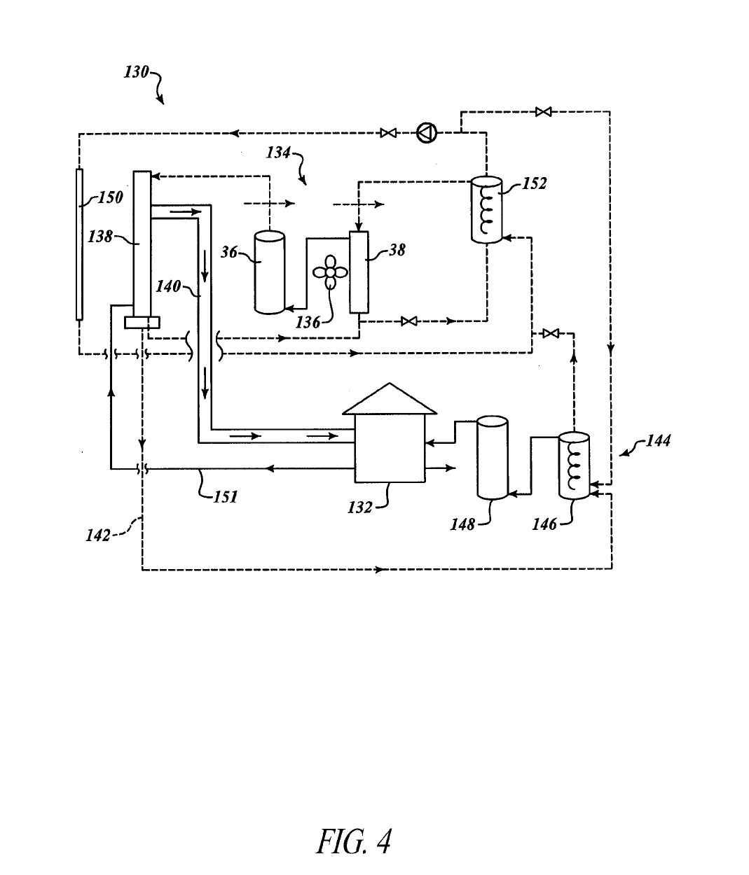

In a further embodiment, best shown in FIG. 4, the atmospheric water generator system 130 can be used on a larger scale, such as an HDACW—Heating Dehumidifying Air-Conditioning and Water system. An atmospheric water generator may be mounted outside of a building 132. Air is pulled into the intake area 134 by a fan 136, passing across one or more condensing members or evaporator coils 138, and creating cooled air 140. The compressor pumps the refrigerant through the condenser 38 as shown in FIG. 4. The cooled air 140 is ducted into the building 132 as air conditioning to cool the building 132. Condensate water 142 can be piped directly into the building 132 to provide a cold water source and be treated by the system described above thereby rendering it potable water. Some or all of the water may instead be piped into a heating area 144, such as through a heat transfer tank 146 and/or a hot water heating/storage tank 148, and then provided to the building as a source of hot water. In one aspect of the disclosure, the water is heated by hot gas or air coming off the compressor 36. The heating area may be provided with heat from the refrigeration circuit or any other available source.

Excess air pressure from ducting the air conditioned air into the building may be vented, or may be ducted back to the atmospheric water generator for further dehumidification via duct 151. If dehumidification is desired, the air may be vented back to the condensing member or coils 138, thereby removing more moisture. The dehumidified air is then ducted back into the building 132, while the collected water joins the rest of the water collected from the initial passage of air through the condensing members 138.

Because the initial air intake is exposed to the atmosphere, ice may tend to form around the intake area as the ambient temperature drops. A preheat coil or membrane 150 may be provided in front of an air intake area to warm the air before it passes across the condensing member 138. The preheat coil or membrane 150 may be heated, for example by collected water, which has passed through a heat transfer area, shown in FIG. 4 as a glycol heat transfer tank 152, to achieve a sufficiently high temperature. The preheat coil or membrane 150 may be operative only once the ambient air temperature drops below a certain point, in order to conserve energy.

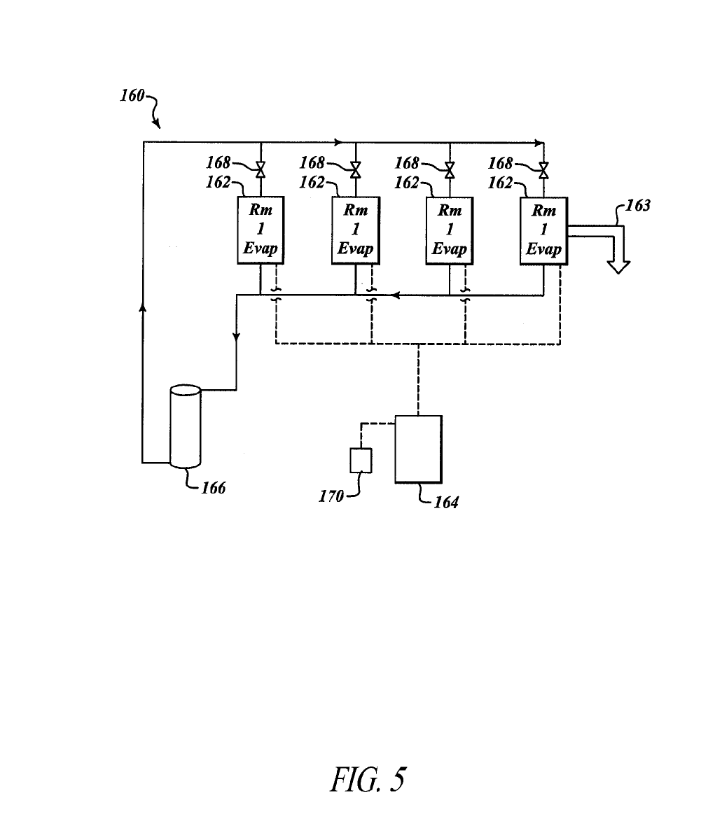

In another embodiment, best shown in FIG. 5, the atmospheric water generator system 160 can be used as multi-zone applications, such as in two or more rooms of a single family house. In one embodiment, one or more evaporation portions 162 of the atmospheric water generator system are located in one or more zones, which may be one or more connected rooms, to dehumidify the air in each zone, and to provide cool air 163 to each zone. The condenser coils 164 and the compressor 166, which may be any suitable type, such as a variable speed, rotary or reciprocating compressor, are preferably located externally. Cooled air may also be ducted to the outside of the building, if air conditioning is not desired. Valves 168 may be used to control whether the evaporation portion in each zone is operational or not, at any given time. The water produced by the evaporation portion may be collected and piped to the collection portion of the atmospheric water generator system, located in a central location, such as a kitchen, where water is typically in higher demand. Alternatively, the piping arrangement may be such that water is collected at two or more primary locations in the area, such as bathrooms, or to one or more storage tanks in, on or under the building. An overflow tank 170 may be added to collect excess water produced by the evaporation portions, and may contain water level indicators, showing when the overflow tank should be emptied.

Alternatively, a roof top HVAC unit is used to generate condensate water that is purified and fed to a room or purified at a “hydro center” in each room of the structure.

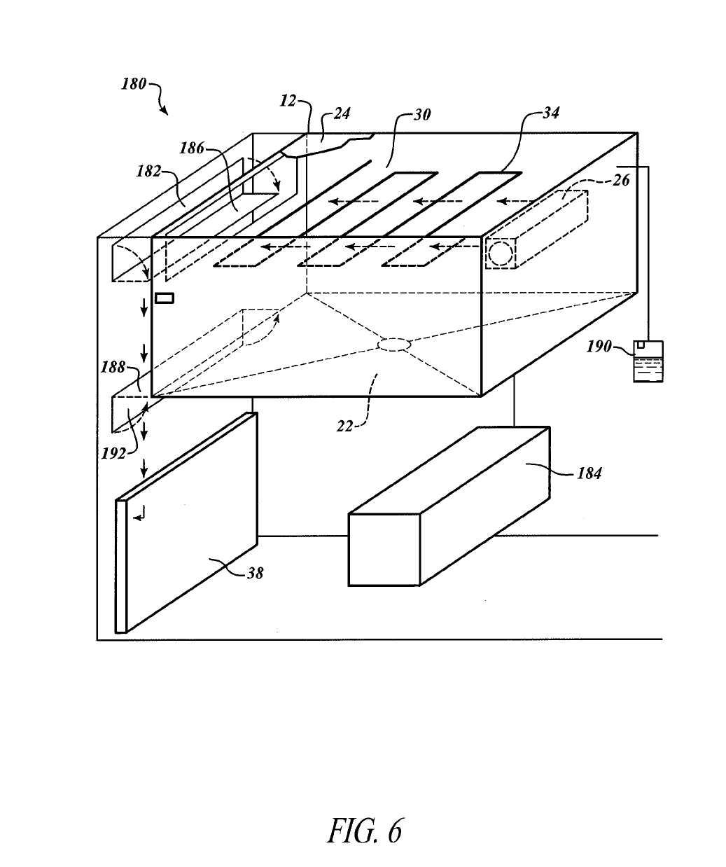

In another embodiment shown in FIG. 6, the atmospheric water generator 180 can be used primarily as an air conditioning unit. In this embodiment, the atmospheric water generator 180 contains similar features as those embodiments in FIGS. 1-3, including the intake fan 26 and water condensing portion 30 of the system and the purification system (not shown), in any suitable form. In order for the atmospheric water generator 180 to operate as an air conditioning unit, an opening 182 is provided across the condensing members from the intake fan 26, in order to simply vent the cooled air directly into the room. A second fan 184 may be provided to cool the interior of a generator housing that contains the tank 12 and the rest of the refrigeration circuit, i.e., the compressor 36 (not shown) and the condenser coil 38.

In order to operate this embodiment as a water generation system, a movable cover 186 is provided to block a first opening 182 in the housing through which the cooled air would otherwise exit after leaving the tank 12. In order to collect water, but not to vent cool air to the room, the flap would cover the opening 182, while a second flap 188 is positioned over a second opening 192 in the housing to allow the cooled air to flow towards and through the condenser coil 38, where it would be warmed before being vented into the room. More particularly, in the water production mode, both flaps or covers 186, 188, are in the vertical position and air passes across the evaporator coil 34, through the condenser coil 38, and the second fan 182 is off. In the air conditioning mode, both flaps 186, 188 are in the horizontal position allowing cool air to exit the first opening 182. The second fan 184 turns on to allow for cooling of the refrigeration circuit. Heat from the first fan 26 is ducted outside through the second opening 192 and cool air from the first opening 182 fills the room. A control system (not shown) for the first and second flaps or covers 186, 188 can be manually implemented or electronically via a computing device, such as a computer system, application specific integrated circuit, or other known electronic control system that is either stand alone or coupled to an intranet or local or global network.

Condensate water may be stored in the generator tank 12 and emptied periodically, or may be collected, purified and dispensed as in any of the above embodiments. A storage or overflow tank 190 may be provided to enable more water to be collected and more air to be cooled before it becomes necessary to empty the tank.

In accordance with another embodiment of the present disclosure, a contact biocide can be used to provide and maintain water purity. This material can provide a non-mechanical way to purify water without the use of UV lights or ozone. Ideally stabilized bromine is used as the contact biocide agent or material. More preferably, the stabilized bromine is presented in the form of a pellet, such as a polystyrene bead that incorporates the bromine to give a controlled release of the bromine into the water. In other words, the bromine migrates to the surface of the bead and kills surrounding bacteria. The beads are replaced when the bromine is depleted. Preferably the water is circulated through this treatment every 4 hours to control bacteria. A GAC filter can be used to scrub the bromine from the water.

In another alternative embodiment, the biocide agent can be coated on the outside of the evaporative coil assembly to reduce the bacteria on the coil assembly.

As will be readily appreciated from the foregoing, the present disclosure provides a variable speed compressor that allows following the dew point and increasing the BTU load as required. The variable speed compressor allows for the InstaCold system that dispenses cold water at the push of a button with minimal time delay at the dispenser or spigot. Moreover, InstaCold and InstaHot can operate in the same chamber. The InstaHot can use the advantages of the variable speed compressor to heat the water as super heated gas is utilized from the main compressor, e.g. 200 degrees Fahrenheit to heat the water, although standard heating and cooling elements can be used as needed. The use of the InstaCold and InstaHot system reduces costs because heating and cooling are provided on demand. A solenoid valve can purge the system daily, or returns the water to the recirculation system.

The variable speed compressor also allows for dehumidifier mode or AC mode as both cycles require different evaporative coil temperatures. It also allows for multi-zone applications or additional zones on one compressor. A water center “Hydro Center” can be developed to be utilized by dishwashers, microwaves, and the like. The Hydro Center can be flush mounted in a cabinet if desired.

Other advantages include the use of desiccant before the corona for a longer life. Ozonated water is bypassed once per day over an internal evaporative coil. A medium pressure UV light can be used to destroy endotoxins, below 240 nm and above 300 nm. A microwave heater can be used to destroy ozone, or hot water from the InstaHot system can be used in the recirculation loop to destroy the ozone. This design will eliminate the need for ozone resistant pumps and other materials, as well as the need for carbon filter vent and downstream filter, because there is no ozone in the tank. The new recirculation design, Hydro Swirl,” eliminates organic and non-organic build up of oxidized materials in the tank. It also eliminates biofilms on the tank internal surfaces. The new tank design allows for sediments and products of ozonation to be gathered to the tank center for filtration.

VaporMax technology allows for additional air scrubbing within the tank because the evaporative coil is inside the main water tank. Coil Clean allows ozonated water or purified water or both to flow over evaporative coils at specified intervals and for re-circulated water to flow over coils, cleaning the cools and cooling the water.

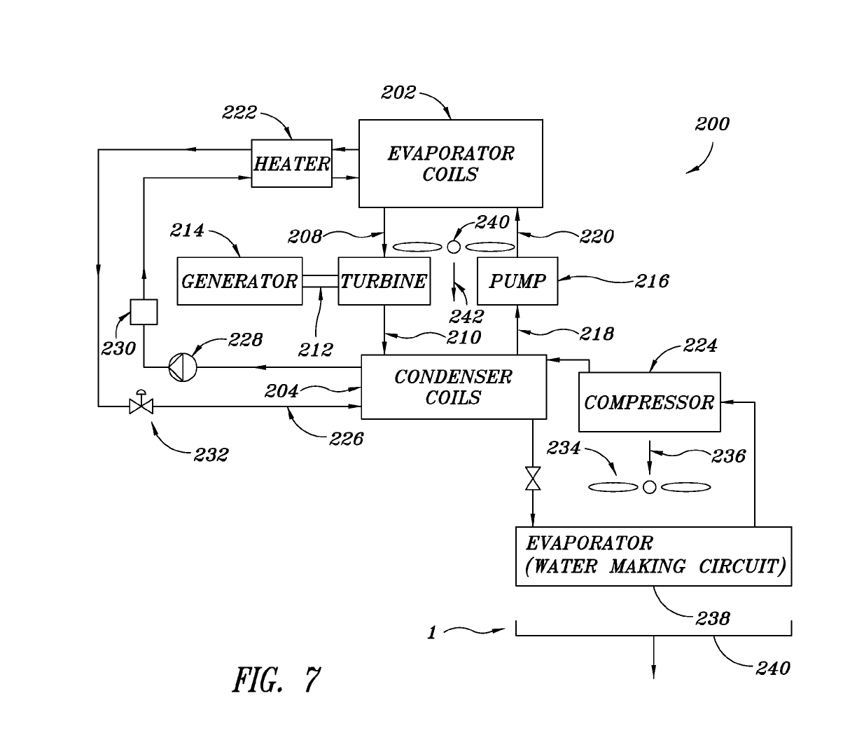

Turning next to FIG. 7, shown therein is an atmospheric water generation system 200 that is self-sustaining in that it provides for electrical power generation while extracting water from the atmosphere. The generation system includes a continuous flow of an operating fluid through an evaporator 202 having evaporator coils and a condenser 204 having condenser coils. A turbine 206 is coupled between the output 208 of the evaporator 202 and an input 210 of the condenser 204. The turbine 206 turns a shaft 212 coupled to an electric generator 214. An increase in gas pressure from the heat transfer fluid as it exits the evaporator 202 activates the turbine 206. A pump 216 is coupled to an input 220 of the evaporator 202 and draws the heat transfer fluid from an output 218 of the condenser 218.

In addition, the heat of rejection from condensor coil 204 may be captured in an additional heat exchanger using a double wall design that isolates the fluid in the condenser coil from a heat transfer circuit 226. The heat transfer circuit 226 has a pump 228, expansion tank 230, and a balancing valve 232 to regulate fluid flow. Fluid may be a glycol solution but not limited to such. The captured heat of rejection may be further used to enhance the efficient operation of a heater 222 and the overall system.

Also shown in FIG. 7 is a fan 234 configured to draw air 236 through an evaporator 238 that generates water, which is collected in a condensate receiving tray 240. The collected water can then be treated and stored as described herein. In addition, a fan 240 is shown below the evaporator coils 202 in FIG. 7 to draw air 242 therethrough.

In operation, a heat transfer fluid is heated by the heater 222, which could be any type of known heating device, such as a conventional heater or more preferably one powered by solar or wind or other green energy source. It circulates in a closed circuit to the evaporator 202 where a heat exchange takes place with the operating fluid. The working fluid in this case is a refrigerant, such as CO2 or some other type of liquid with a low flash point as described above, which is pumped from the condenser 218 to the evaporator 202, where heating takes place. When the boiling point is reached for the working fluid, it converts from a liquid to a gas under increased pressure due to the closed volume of the transmission conduits. The turbine 206 uses this pressure to turn the shaft 212 on the generator 214 and thereby generate electric power to be used by the system.

The gaseous operating fluid is cooled in the condenser 218 to below its nominal boiling point. A compressor 224 having its own working fluid that circulates in a closed loop with the condenser 218 to bring the operating fluid down in temperature and to change phase to a liquid. After this, a new cycle begins. Water extraction takes place at the evaporator coils using the water generator described above in connection with FIGS. 1-13.

Noise cancellation technology can also be applied to the water generation systems describe above, both passive and active. Readily commercially available “Active Noise Control” solutions provide undisturbed airflow while reducing disturbing noise. Active cancellation utilizes an “anti-noise” signal that interferes with and cancels out the original sound. In one approach, algorithms are used to adaptively follow changes in noise spectrum to achieve about 10 dB (A) of noise reduction. It allows undisturbed airflow while preventing noise from being emitted from the generation system. Another commercially available solution extends a low frequency range of signals, up to 1800 Hz, with single or multiple tones.

This technology is adapted for any fan dimension or to any air device, such as blowers, that are used as described above to draw air into the evaporator. An add-on duct unit can be used for the end of a pipe emitting or sucking air and generating noise.

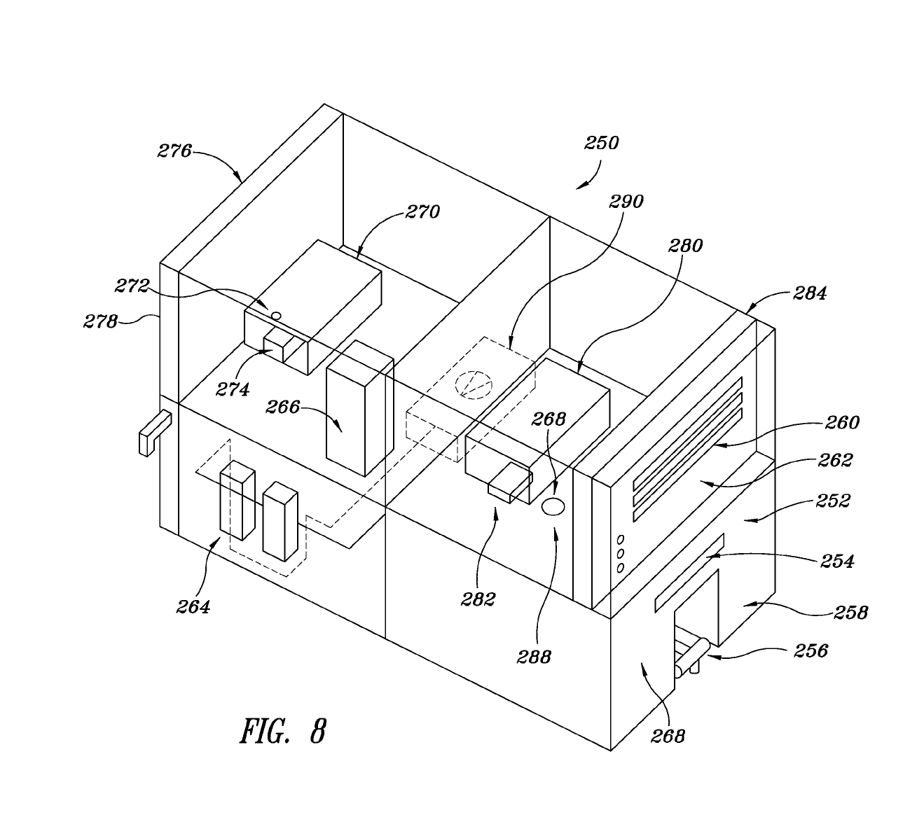

FIG. 8 illustrates a representative stand-alone design for a water generation, treatment, and dispensing system. As shown, the system 250 has an upper portion and a lower portion, and each portion is divided into two sections. Included in the system 250 are a housing 252 having a display control panel 254 and dispenser 256 on a first lower side wall 258 beneath an air inlet grating 260 on a first upper side wall 262. The system housing has a lower half in which are found the water filters 264, compressor 266, and storage tank 268 coupled to the dispenser 256. In one application, the side wall 258 would be positioned on the interior of a dwelling and the structure to the left of the side wall 258 would be on the exterior of the dwelling.

The upper portion of the system housing includes a first half having a fan 270 with an atmospheric particle sensor 272 and air inlet filter 274 for use with a condenser coil unit 276 that is mounted on or forming part of a second upper side wall 278. In a second half of the upper portion is a fan 280 with an air inlet filter 282 that draws ambient or outside air through an evaporative coil unit 284 structured to condense and extract moisture from the air, which collects on a floor or collection pan 286. The pan 286 is preferably concave in shape with a water inlet 288 at the lowest point to direct the water condensate product to the storage tank 268 in the lower portion of the housing.

This configuration allows for the heat of rejection from the heat pump cycle to be exhausted to the exterior of the dwelling. Because the condenser circuit is outside, the heat of rejection is not exhausted into the dwelling. The air conditioning grills may also be configured with a series of dampers that are structured to allow the cold air to be exhausted to the outside. This is required when the unit is in a water-making mode and no air conditioning is required. When the unit is in air-conditioning mode and the lower storage tank is full, then the excess water simply drawing out of the overflow to the ground or another tank or to a waste disposal system.

A bacteria control unit 290 in the lower portion is coupled to the water filters 264. Bacteria control can be gravity fed. Treatment of the water can be with an LED ultra violet light or biostatic filter or both or with standard UV or ozone in the embodiments shown in FIGS. 1-13.

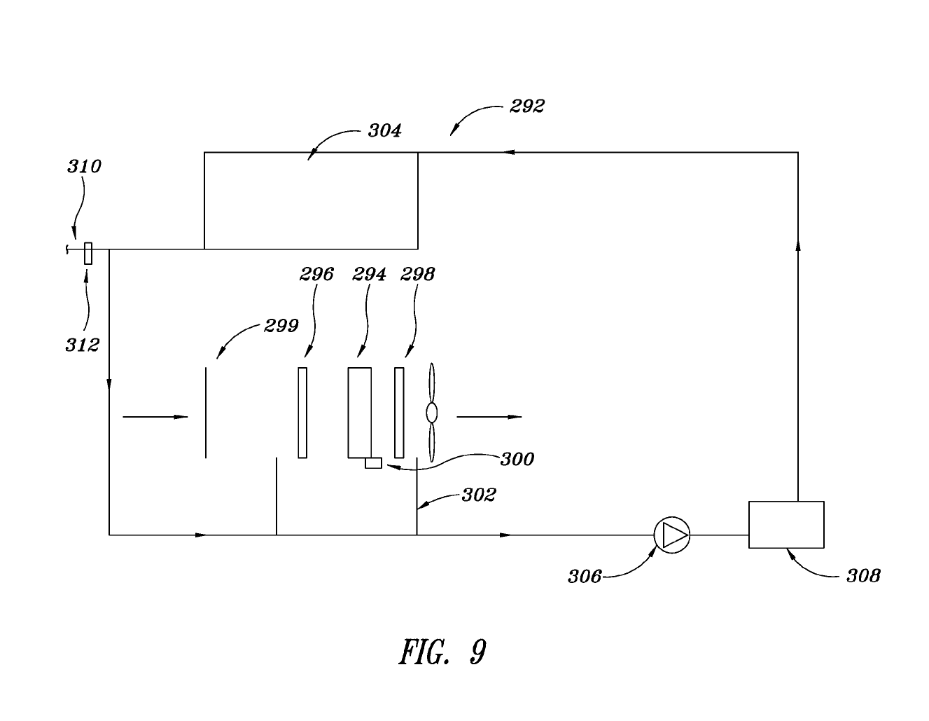

FIG. 9 is a diagram of a recirculating water generation system 292 in which a dehumidification desiccant wheel 294 is used to extract additional moisture from the air. The wheel 294, which is positioned between a condenser coil 296 and a heater 298, is turned by a motor 300. Air flow drawn through an air filter 299 and passing from the condenser coil 296 passes over a portion of the rotating wheel 294 to capture residual moisture in the air. The wheel 294 then rotates through a regeneration zone in which heat from the heater 298 removes the moisture from the wheel 294, which is collected in the tank 302 positioned below the wheel 294. As shown in this version, the air passes through the wheel 294 on one side and exits on the side next to the heater 298, which heats that side of the wheel 294 to drive the moisture from the wheel 294.

The water generation system may be external to the storage tank 304 or internal as described above in connection with FIGS. 1-13, which also encompasses different methods of bacteria control. As shown in FIG. 9, a recirculation line 306 couples the storage tank 304 to the condensate tank 302 and a pump 306 pumps the condensate to the tank 304 through a filtration system 308. A dispenser 310 with carbon filter 312 is coupled to an outlet on the tank 304.

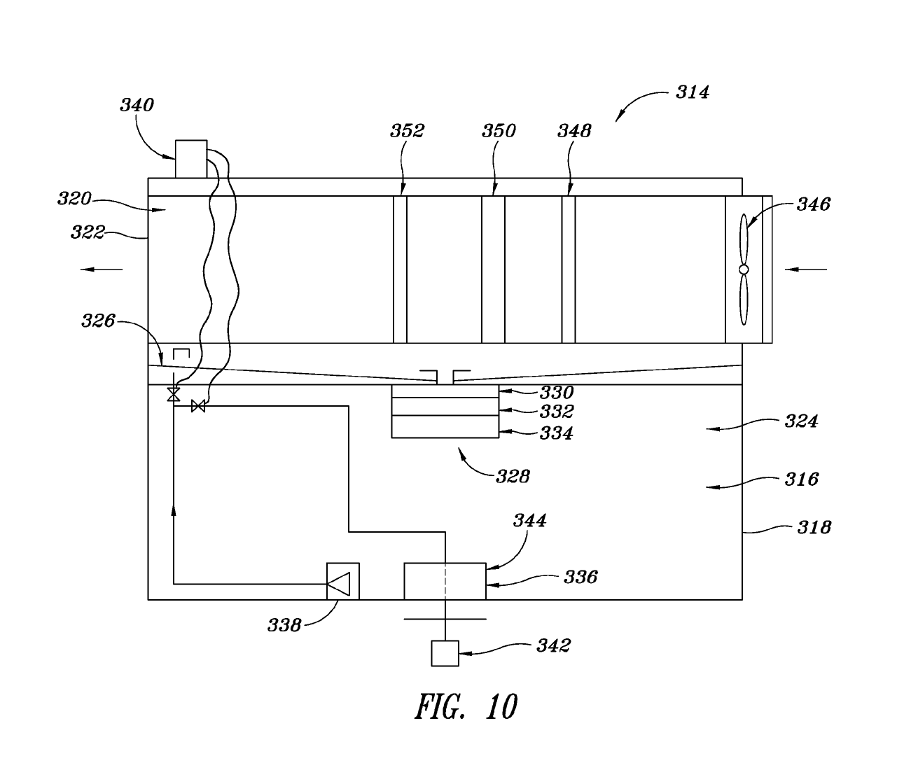

In the system configuration 314 of FIG. 10, a bi-level design has a tank 316 in the lower level 318, a water extraction unit 320 in an upper level 322, and a water collection and treatment interface 324 positioned there between. A collection plate 326 catches and directs the condensate product to the tank 316 via a tri-level filter328. The filter 328 has a first layer or top level biostatic filter 330 or LED UV treatment followed by a sediment layer 332 that in turn is followed by a carbon layer 334.

Because the residuals in the water that are created when water passes through the tri filter may be undesirable, a dispenser 336 may be configured to allow for the addition of a carbon filter. Activated carbon is known to neutralize the residuals of bromine in the water, thereby scrubbing off all remaining bromine before the water is consumed. In addition to a normal gravity flow dispensing method, a pump 338 may be used to provide a more positive means of dispensing water. In normal operation, SV-2 is closed and SV-1 is opened to allow for circulation of the water to control bacteria. In the dispensing mode, a PLC controller 340 coupled to SV-1 and SV-2 will sense the signal from a pressure pad 342 located within the dispensing well. The PLC controller 340 will then open SV-2 and close SV-1 until the pressure pad 342 is deactivated. This configuration for dispensing can also be used in the embodiments described above with respect to FIGS. 1-6. A cooling and heating chamber 344 can be used at the dispenser to chill or heat the water at the time it is dispensed.

The water extraction unit 320 includes a fan 346 drawing air over a condenser coil unit 348, across a dessicant wheel 350, and them across a heater 352. Its operation and function are similar or identical to that described above with respect to the other water extraction units.

Not shown in this embodiment are the water collection fins on the evaporator coils. In order to reduce bacteria and harmful microbes, the fins can be treated. Ideally a “Bronz Glow” product can be used as a coating for the evaporator coil. The coating has anti-microbial properties and the ability to expand and contract with the evaporator coils and not crack, which can expose the aluminum fins to the water, causing aluminum oxide in the water and creating a place for bacteria to grow. These coatings also have excellent thermodynamic properties, which avoids having to increase the amount of BTUs to compensate for poor heat transfer. Hydrophlic Coatings on the aluminum fins can be used because they have very good water beading qualities as do the Bronz Glow coatings. Both of these coatings have a low contact angle allowing the water to fall from the coils faster, thus providing for less evaporation on the evaporator coil as warm air passes over them. This is particularly advantageous in areas of low humidity and high ambient air temperature, like the desert, because the water droplets that collect on the coil can quickly be evaporated and thereby reducing the water production amounts. The goal is to remove the water off the coil as quickly as possible.

Additional bacteria control is available through other means, such as a Polyethersulfone Ultrafilteration Membrane to control bacteria in the water. Carbon Nano Filters can also be effective at controlling bacteria in the water. Radio frequency signals can also be directed through the water in the storage tank to control bacteria.

FIG. 11 shows a system 354 similar to that illustrated in FIG. 10 and in which the same reference numbers are used for the same components. In this version, the evaporator coil 356 is shown in the middle of the water extgraction unit 320 and alternative locations for the compressor are shown in dashed lines. The compressor 362 can be upstream or downstream of the evaporator coil 356. Condensate 358 passes through the filter system 328 and exits as purified water 360 into the tank 316.

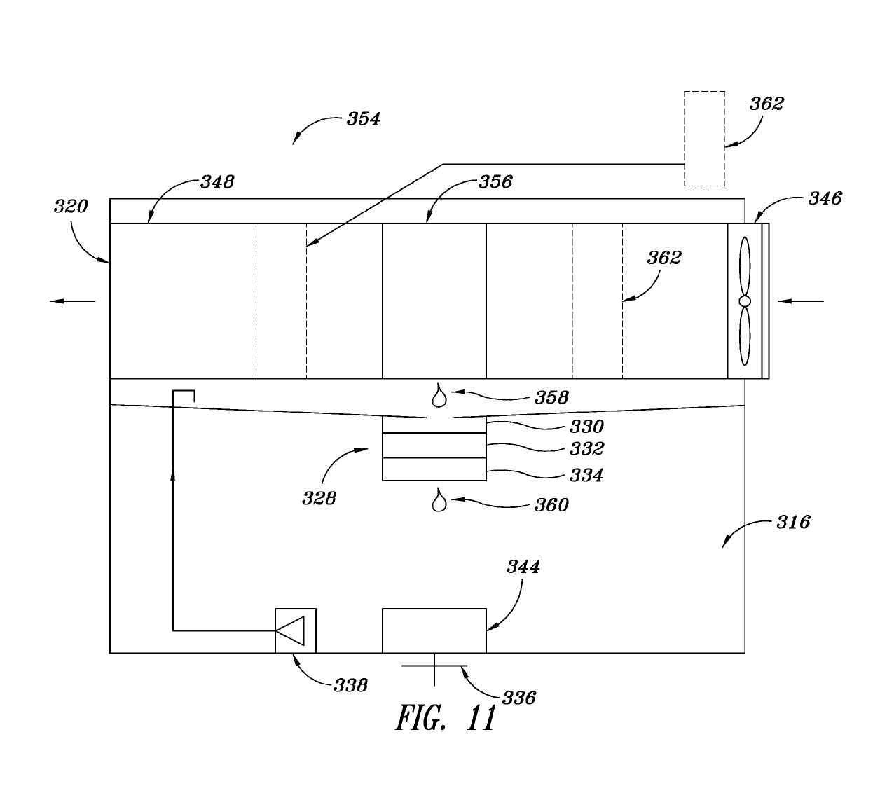

In FIG. 12, an AC power supply system 364 is shown in association with an enclosed structure 366, such as a residential, governmental, or commercial building. The AC power supply can be generated from a solar panel 368 or a wind turbine 370 generating DC current, either alone or in combination with each other. An inverter 372 can be used to convert the DC to AC. Instead of an inverter, “Fly Back” technology can be used to configure the DC current for use with an induction motor.

Flyback Technology uses the magnetic field produced by an inductive device, such as an electric motor, and then controls and directs that field in all of its rising, falling and static states. By taking energy from the electrical circuit, storing it in a magnetic field, and subsequently returning this energy to the circuit, efficiency is greatly increased. The capture of this energy substantially reduces the heat that electrical motors generate and it eliminates EMI (electromagnetic interference). EMI is a disturbance that affects an electrical circuit that may interfere with other electronic equipment. Eliminating EMI is important due to the international rules that all manufacturers must abide by when with respect to acceptable levels of EMI.

The controller is designed to enable the input to be either AC or DC, allowing an AC motor to run with DC input without the use of inverters, which are highly inefficient when running at the minimal power levels required of the foregoing systems and devices to produce water. Flyback Technology does not convert DC to AC but changes DC to a non-sinusoidal, periodic waveform that can be used to power AC devices, such as motors. Using Flyback Technology greatly reduces the number of photo voltaic (solar) cells and batteries needed to run the water generation machines. Most significant is when using wind or solar power as a power source, in combination with the Flyback Technology, no inverters are needed. This is a first in electrical power generation systems. The elimination of the power loss associated with current inverter technology—which can be 25% to 30%—results in a substantial savings of power, cost and increase in efficiency.

When using off-grid power sources such as wind or solar power with Flyback Technology—98% of the energy generated will be delivered to the end source (motor-power, etc.). This could reduce the number of solar panels by 25% while still producing the same amount of power to the end user or system, power that is cleaner, emitting less heat and with no EMI. This technology will enhance the use of water generation machines, reduce power consumption worldwide, and greatly reduce the Carbon Footprint associated with fossil fuel power generation.

FIG. 12 shows alternate locations for the atmospheric water generation unit 374 that can be configured with alternating current electricity output 376 and water output 378, in which the water is generated in accordance with the afore-described embodiments. The electricity can be used to recharge a battery system 380, such as lithium ion batteries.

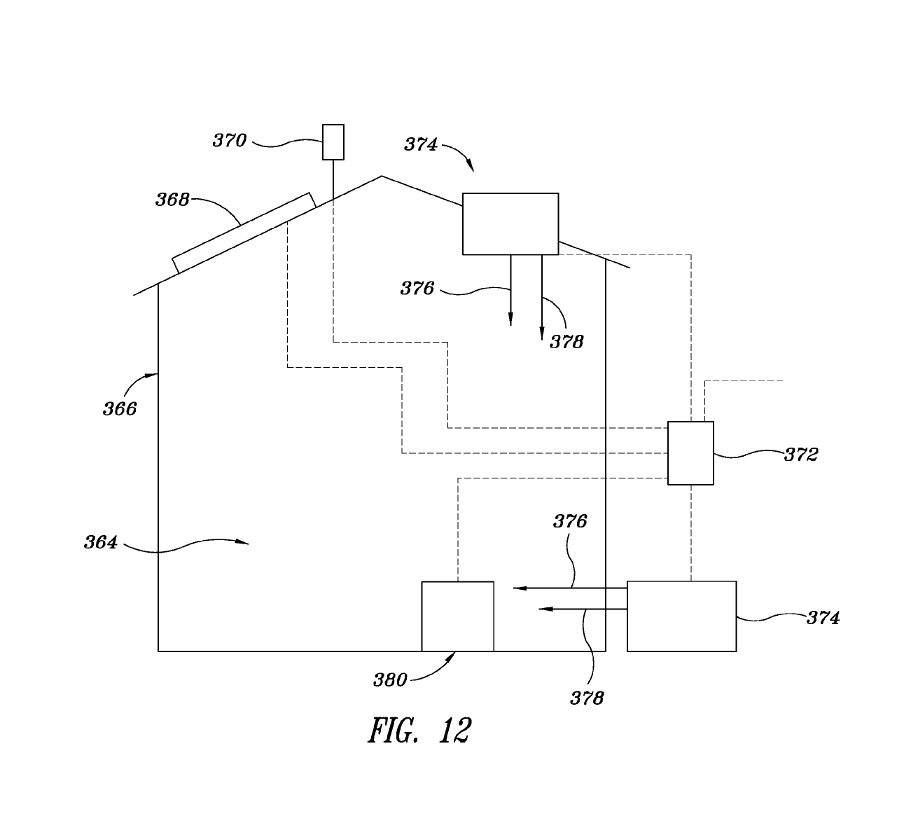

FIG. 13 illustrates a greenhouse water recirculation application 382 in which water from an air water generator is used to hydrate plants in the greenhouse 384. Elements in common with FIG. 12 bear the same reference numbers. In this particular application, a hydroponic table 386 with plants 388 is shown in which water vapor 390 from the plants 388 is captured by the water generation system 392 and water generated therefrom is used to hydrate the plants 388 via a pump 396. A damper 394 is used to control humidity. When the relative humidity percentage drops below a set point, the damper opens to allow air 398 with a higher relative humidity percentage inside the greenhouse.

It is to be understood that in one or more embodiments described above, the compressor can be one that is oil-less. Non-oil compressors are lighter and less costly and provide air that is oil free. However, such compressors can have a higher level of noise, in which case a noise reduction or cancellation system can be utilized as described above. One available compressor is the Turbocor available from Danfoss Turbocor Compressors, Inc.

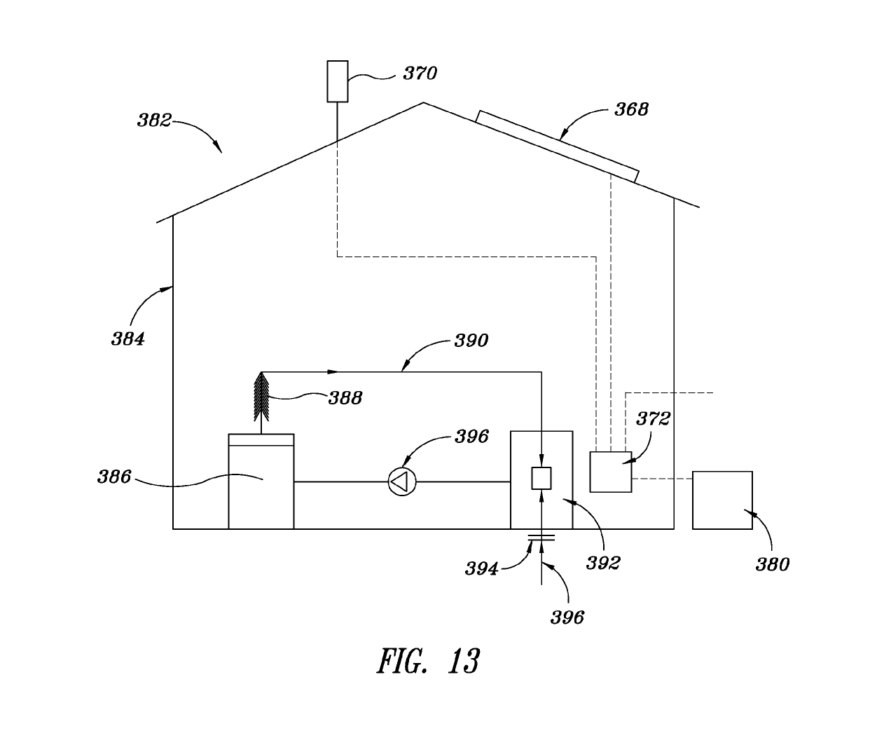

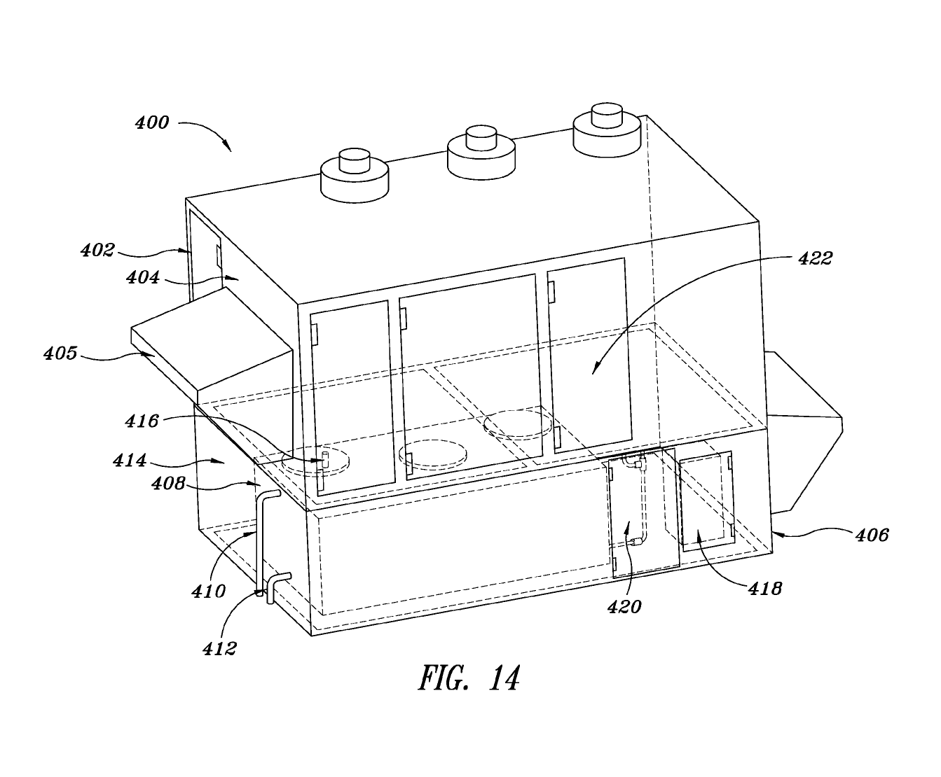

FIGS. 14-16 illustrate another aspect of the present disclosure in which a self-contained water generation system 400 is provided. The system 400 incorporates one or more of the features and systems described in this disclosure. Here, the water generation unit is enclosed within an upper half 404 of the system housing 402 and the tank 408 is in the lower half 406 of the housing 402. Inlet pipes 416 are provided on the top of the tank 408, and an overflow pipe 410 with bug screen is provided on the tank 408 along with a manual drain valve or pipe 412. An access door 414 is provided for removal of the tank 408.

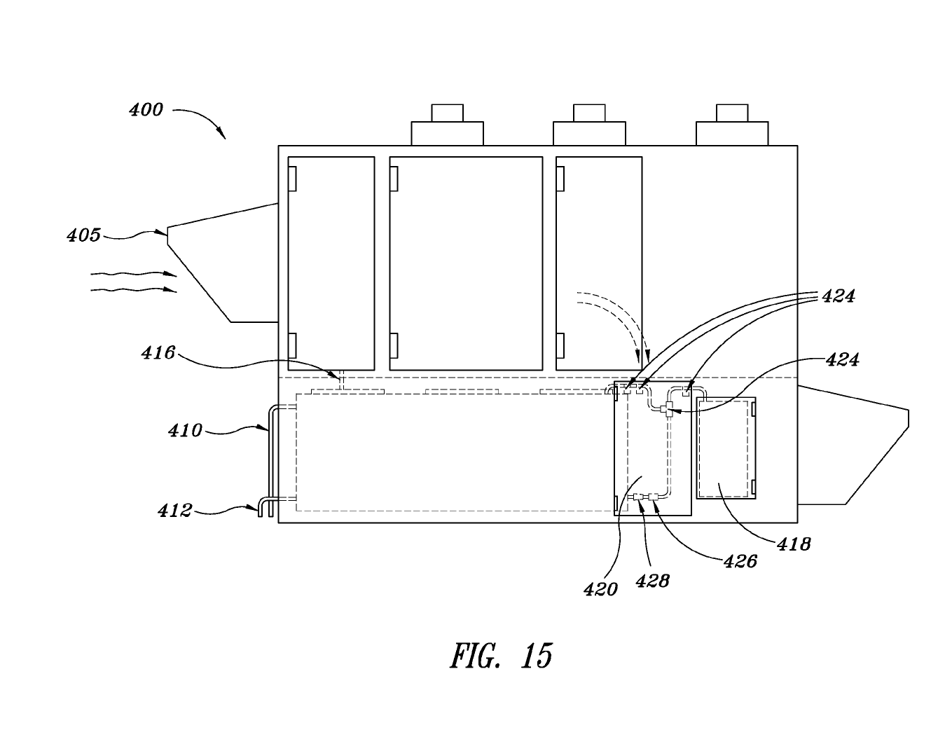

A dispensing well 418 is formed in the lower half 406 to facilitate the filling of A 5-gallon bottle from the tank 408. In addition, a filter access door 420 next to the dispensing well 418 facilitates replacement of filters 424. An opening 422 is provided between units to provide for air flow. As seen in FIG. 15, a three-way solenoid 424 controls water flow to a pump 426 and strainer 428 at the tank 408.

In operation, air is drawn into an air inlet 405, through the water generation unit, and then through the opening 422 into the lower half 406. The cold air from the upper half 404 cools the water tank 408.

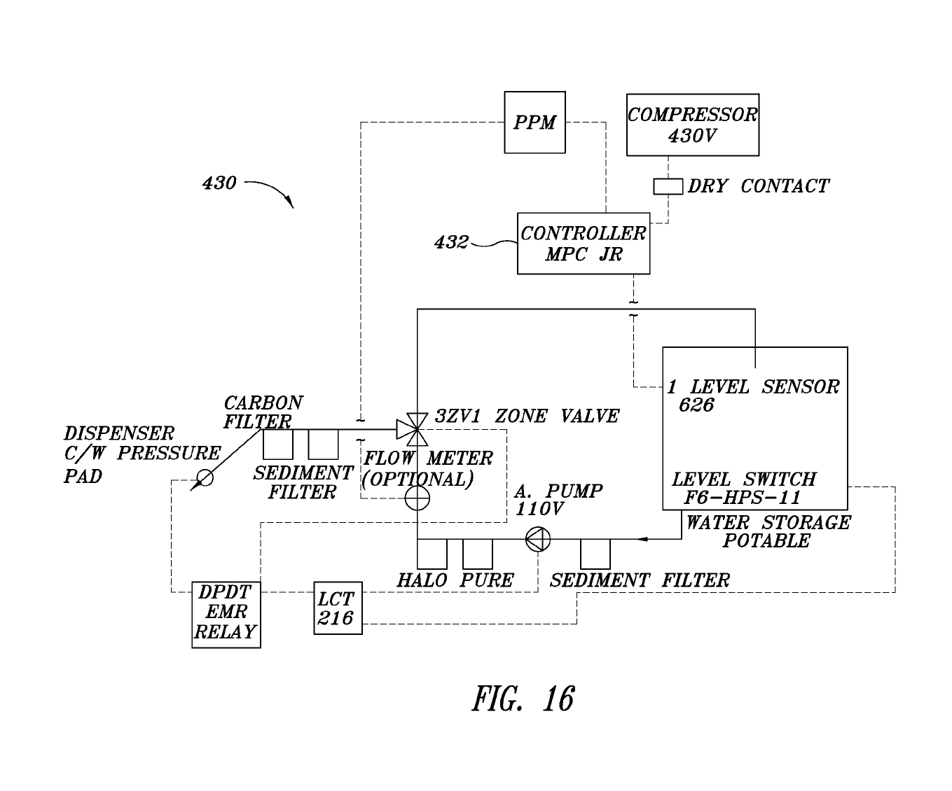

FIG. 16 shows a control system 430 for the system 400 of FIGS. 14 and 15. A controller is provided that monitors signals from a bromine sensor in the tank. When bromine is below a preset parts-per-million level, the system compressor is turned off. Also, if the level sensor indicates the tank is at a predetermined level, the compressor is turned off, otherwise the compressor is turned on. Visual indicators are provided and visual and audible alarms are provided for conditions requiring operator action. The controller can be configured to connect to the internet to permit remote monitoring and control of the system 400. This type of web-based system monitors the functioning of the units, such as pressures, air flows, temperatures, and can adjust fan speed accordingly. Hence, web-based management is facilitated with the use of the PLC coupled to the internet or a world-wide network of computers, or a similar type of management system configured to work with an intranet or private computer network. Alternatively, the web-based system can enable an owner of the unit to control its operation, including enabling and disabling the unit as conditions and circumstances require. Optionally, a Programmable Logic Controller (PLC) can be configured to accommodate a USB device that is used by a commercial or residential customer to provide uploads to the controller.

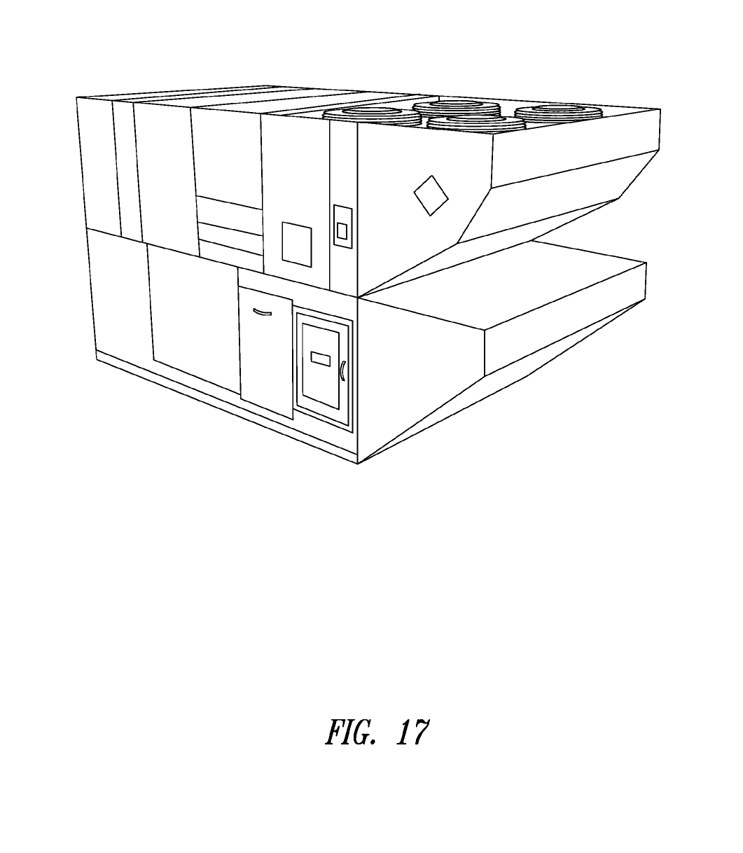

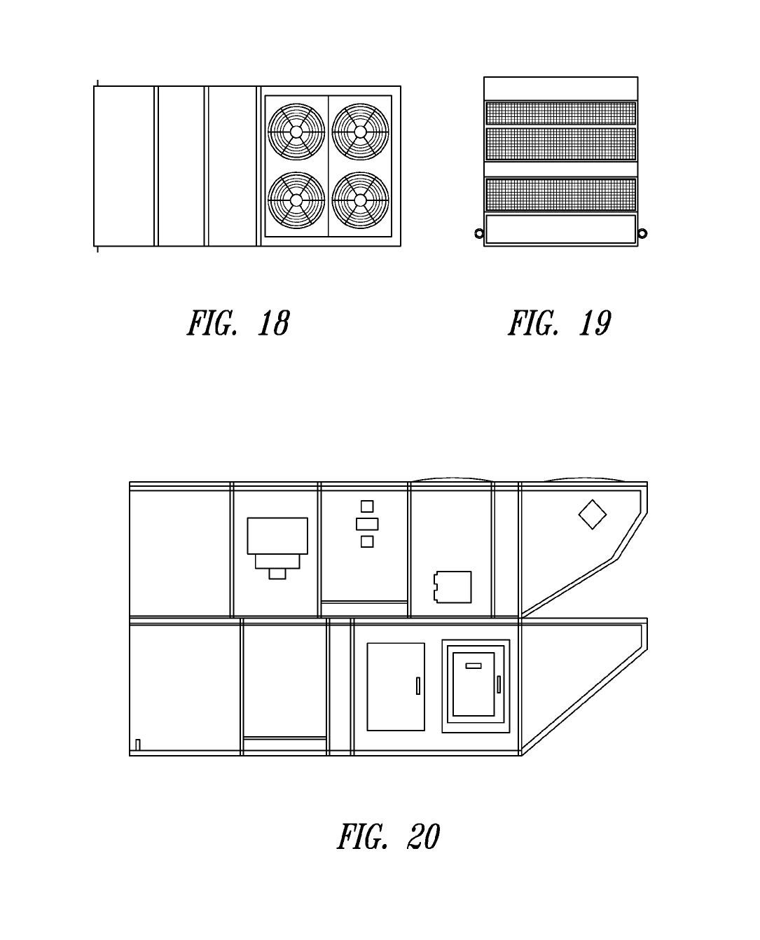

FIGS. 17, 18, 19, and 20 are an isometric, top, front, and side views, respectively of an alternative design for a larger capacity tank, such as a 400 gallon tank, whereas the design shown in FIGS. 14-15 is of a lower volume, somewhere in the 325 gallon range. Features and systems described above in conjunction with FIGS. 1-16 can be incorporated individually or in any combination into the design shown in FIGS. 17-20. In this larger unit, the premise is to convert an existing HVAC unit into a water generation unit. With this conversion, only about 35% outside air is used and 65% inside air from a structure is used. This is useful in very high temperature environments where motors can be damages more easily from overheating.

It will therefore be appreciated by those skilled in the art that the preferred and alternative embodiments have been described in some detail but that various modifications may be practiced without departing from the principles of the disclosure. For example, the air filter may be either a HEPA filter or a carbon impregnated filter made of paper or other suitable material. In addition, “deep coil” technology can be incorporated into any of the foregoing designs and systems provided in this disclosure. Deep coil technology slows the air and scrubs more moisture from the air. The number of fins per inch drop from 12 to 4 using wider fin spacing and increased coil depth to increase air dwell time. With this technology, the face pressure or face velocity is lower, e.g., from 600 cfm to 300 cfm, which decreases noise, energy, and cost because smaller parts can be used.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a tank;
a water condensation unit having a fan and an evaporator coil assembly;
a continuous heat transfer fluid system having a fan, an evaporator coil assembly, and a condenser unit, the fan configured to draw air across the evaporator coil assembly and to generate condensate water on the evaporator coil assembly that falls and collects in the tank, and further including a pump coupled to an input of the evaporator coil assembly and structured to draw heat transfer fluid from an output of the condenser;
a turbine coupled between an output of the evaporator and an input of the condenser, the turbine structured to turn a shaft coupled to a device configured to generate electricity, the turbine structured to be actuated by an increase in gas pressure from heat transfer fluid as it exits the evaporator coil assembly.

2. The system of claim 1 further comprising a purification unit in liquid communication with the interior of the tank, the purification unit having an ozone injector structured to inject ozone into water drawn from the tank, and an ozone filter positioned immediately after the ozone injector and structured to remove ozone from the water exiting the ozone injector, a return line exiting the ozone filter and in liquid communication with the interior of the tank to return the filtered water to the tank, and a distribution system mounted inside the tank and in fluid communication with the return line, the distribution system structured to move the water in the tank to prevent stagnation and to scrub interior surfaces in the tank that are in contact with the water; and
a dispensing unit in liquid communication with the interior of the tank and structured to dispense water outside the tank, the dispensing unit comprising a heating-cooling assembly that is structured to heat or cool the water at the time the water is dispensed from the dispensing unit.

3. The system of claim 1, wherein the water condensation unit comprises an oil-free compressor.

4. The system of claim 1, wherein the water condensation unit comprises a programmable logic controller configured to be coupled to a network of computers and enable remote management of the system.

5. The system of claim 4, wherein the network of computers is the internet and the remote management comprises a web-based management system.

6. The system of claim 5, comprising a solar panel or a wind generator coupled to the water condensation unit to provide electric power to the water condensation unit.

7. The system of claim 6, comprising an inverter coupled to the water condensation unit and configured to convert DC current from the solar panel or wind generator to AC current.

8. The system of claim 6, comprising a fly-back device coupled to the water condensation unit and configured to configure DC current from the solar panel or wind generator to DC current suitable for use by the water generation unit.

9. The system of claim 1, further comprising a hydroponic system configured to generate water vapor, and wherein the water condensation unit is in fluid communication with the hydroponic system to receive the water vapor and convert the water vapor to a liquid.

10. The system of claim 1, comprising an air flow system that directs cold air from the water condensation unit to the tank to cool the tank and water in the tank.

11. An ozone-free water generation system, comprising:
a tank;
a water condensation unit having a continuous heat transfer fluid system having a fan, an evaporator coil assembly, and a condenser unit, the fan configured to draw air across the evaporator coil assembly and to generate condensate water on the evaporator coil assembly that falls and collects in the tank, and further including a pump coupled to an input of the evaporator coil assembly and structured to draw heat transfer fluid from an output of the condenser;
a turbine coupled between an output of the evaporator and an input of the condenser, the turbine structured to turn a shaft coupled to a device configured to generate electricity, the turbine structured to be actuated by an increase in gas pressure from heat transfer fluid as it exits the evaporator coil assembly
a purification unit in liquid communication with an interior of the tank, the purification unit configured to purify the water in the tank;
a distribution system mounted inside the tank and structured to move the water in the tank to prevent stagnation and to scrub interior surfaces in the tank that are in contact with the water; and
a dispensing unit in liquid communication with the interior of the tank and structured to dispense water outside the tank.

12. The system of claim 11, wherein the dispensing unit comprises a heating-cooling assembly that is structured to heat or cool the water at the time the water is dispensed from the dispensing unit wherein the heating-cooling assembly is mounted in the interior of the tank.

13. The system of claim 11 comprising at least one filter mounted on a wall of the tank and replaceable from outside the tank.

14. The system of claim 11, wherein the water condensation unit comprises an oil-free compressor.

15. The system of claim 11, wherein the water condensation unit comprises a programmable logic controller configured to be coupled to a network of computers and enable remote management of the system.

16. The system of claim 15, wherein the network of computers is the internet and the remote management comprises a web-based management system.

17. The system of claim 16, comprising a solar panel or a wind generator coupled to the water condensation unit to provide electric power to the water condensation unit.

18. The system of claim 17, comprising an inverter coupled to the water condensation unit and configured to convert DC current from the solar panel or wind generator to AC current.

19. The system of claim 17, comprising a fly-back device coupled to the water condensation unit and configured to configure DC current from the solar panel or wind generator to DC current suitable for use by the water generation unit.

20. An air water generation system, comprising:
a continuous heat transfer fluid system having an evaporator, a condenser unit, and a pump coupled to an input of the evaporator and structured to draw heat transfer fluid from an output of the condenser;
a turbine coupled between an output of the evaporator and an input of the condenser, the turbine configured to rotate a shaft, the turbine configured to be actuated by an increase in gas pressure from heat transfer fluid in the continuous heat transfer fluid system as it exits the evaporator; and
a device configured to generate electricity, the device coupled to the shaft and configured to generate electricity in response to rotation of the shaft.

21. The system of claim 1, further comprising a tank configured to receive and store condensate generated by the continuous heat transfer fluid system, and a purification unit in liquid communication with an interior of the tank, the purification unit having an ozone injector structured to inject ozone into water drawn from the tank, and an ozone filter positioned immediately after the ozone injector and structured to remove ozone from the water exiting the ozone injector, a return line exiting the ozone filter and in liquid communication with the interior of the tank to return the filtered water to the tank, and a distribution system mounted inside the tank and in fluid communication with the return line, the distribution system structured to move the water in the tank to prevent stagnation and to scrub interior surfaces in the tank that are in contact with the water; and
a dispensing unit in liquid communication with the interior of the tank and structured to dispense water outside the tank.
